(19) United States
(12) Patent Application Publication
(10) Pub. No.: US 2015/0248027 A1
(43) Pub. Date: Sep. 3, 2015

(54) DISPLAY DEVICE AND LIQUID CRYSTAL LENS PANEL DEVICE FOR THE SAME

(71) Applicant: Samsung Display Co., Ltd., Yongin-City (KR)

(72) Inventor: Yoon Kyung PARK, Seoul (KR)

(21) Appl. No.: 14/455,439

(22) Filed: Aug. 8, 2014

(30) Foreign Application Priority Data
Feb. 28, 2014 (KR) 10-2014-0024336

(51) Int. Cl. G02F 1/1339; G02F 1/1343; G02F 1/1333; G02B 27/22; G02F 1/133

(52) U.S. Cl. CPC G02F 1/1339; G02B 27/22; G02F 1/13306; G02F 1/133345; G02F 1/134309

(57) ABSTRACT

A liquid crystal lens panel includes a display area and a periphery area disposed outside the display area. A first substrate including a plurality of linear electrodes is disposed in a display area. A plurality of bus lines is disposed on a periphery area. A common voltage line is disposed parallel to the plurality of bus lines The liquid crystal lens panel includes a second substrate including a common electrode. The second substrate faces the first substrate. A sealing member is disposed along the periphery area and bonds the first substrate and the second substrate to each other. The common voltage line is disposed between each of the plurality of bus lines. The sealing member is disposed on the common voltage line. The sealing member electrically connects the common voltage line and the common electrode.

### CROSS-REFERENCE TO RELATED APPLICATION

This application claims priority under 35 U.S.C. §119 to Korean Patent Application No. 10-2014-0024336 filed in the Korean Intellectual Property Office on Feb. 28, 2014, the disclosure of which is incorporated by reference herein in its entirety.

### TECHNICAL FIELD

Exemplary embodiments of the present invention relate to a display device and more particularly to a liquid crystal lens panel device for the same.

### DISCUSSION OF RELATED ART

A display device may include a three-dimensional (3D) stereoscopic image display device.

A stereoscopic image may be displayed by using binocular disparity. In binocular disparity, an image reaching the left eye and an image reaching the right eye may be displayed on the same display device, and the two images may be respectively incident to the left eye and the right eye of an observer.

A barrier or a lenticular lens may be used to ensure that each eye receives its respective image.

In a stereoscopic image display device using the barrier, a slit may be formed at the barrier, and the image from the display device may be divided into a left eye image and a right eye image through the slit.

In the stereoscopic image display device using the lens, a left eye image and a right eye image may be displayed, and the image from the stereoscopic image display device may be divided into the left eye image and the right eye image by changing an optical path of the image.

The display device may display a two-dimensional image and a three-dimensional image. The display device can display a plane image and a stereoscopic image, and may include a liquid crystal lens panel switching between the plane image and the stereoscopic image.

The display device may have a relatively small periphery outside the display area.

### SUMMARY

Exemplary embodiments of the present invention may provide a display device with a relatively small periphery and a liquid crystal lens panel device for the same.

An exemplary embodiment of the present invention provides a liquid crystal lens panel including a display area and a periphery area disposed outside the display area. A first substrate including a plurality of linear electrodes is disposed on the display area. A plurality of bus lines is disposed on the periphery area. A common voltage line is disposed parallel to the plurality of bus lines. The liquid crystal lens panel includes a second substrate including a common electrode. The second substrate faces the first substrate. A sealing member is disposed along the periphery area and bonds the first substrate and the second substrate to each other. The common voltage line is disposed between each of the plurality of bus lines. The sealing member is disposed on the common voltage line. The sealing member electrically connects the common voltage line and the common electrode.

The liquid crystal lens panel may include a first insulating layer disposed on a first substrate.

The plurality of linear electrodes may include a plurality of first linear electrodes and a plurality of second linear electrodes connected to the plurality of bus lines. The plurality of first linear electrodes may be disposed on the first insulating layer.

The liquid crystal lens panel may include a driving IC configured to apply a driving voltage to the plurality of bus lines. A plurality of first driving lines may connect the driving IC and the plurality of bus lines.

The first driving lines may be disposed on the first insulating layer.

A second driving may connect the driving IC and the common voltage line. The driving IC may be configured to apply a common voltage to the common voltage line.

The second driving line may be disposed on the first insulating layer.

A second insulating layer may be disposed on the first insulating layer. The second linear electrodes may be disposed on the second insulating layer.

A third insulating layer may be disposed on the second insulating layer and may insulate the second linear electrodes from the sealing member.

Ohmic contacts may be disposed on the third insulating layer. The ohmic contacts may be electrically connected to the common voltage line through a contact hole exposing at least part of the common voltage line.

A plurality of contact holes may be disposed at regular intervals on the common voltage line.

The sealing member may be disposed on the ohmic contacts, and an upper portion of the sealing member may be in contact with the common electrode.

A liquid crystal layer may be disposed between the first substrate and the second substrate. The sealing member may seal the liquid crystal layer.

An exemplary embodiment of the present invention provides a display device including a display panel configured to display an image. A liquid crystal lens panel is configured to operate in a two-dimensional (2D) mode displaying a 2D image and a three-dimensional (3D) mode displaying a 3D image. The liquid crystal lens panel includes a first substrate including a plurality of bus lines disposed on a periphery of the liquid crystal lens panel. The periphery is disposed outside the display area. A common voltage line is disposed between each of the plurality of bus lines. The liquid crystal lens panel includes a second substrate including a common electrode. The second substrate faces the first substrate. A sealing member is disposed on the common voltage line. The sealing member bonds the first substrate and the second substrate to each other. The sealing member electrically connects the common voltage line and the common electrode.

A first insulating layer may be disposed on the first substrate.

The liquid crystal lens panel may include a plurality of first linear electrodes disposed on the first insulating layer. The first linear electrodes may be connected to the bus lines. A driving IC may be configured to apply a driving voltage to the bus lines. A plurality of first driving lines may be disposed on the first insulating layer and may connect the driving IC to the bus lines.

A second driving line may be disposed on the first insulating layer and may connect the driving IC and the common voltage line.

The liquid crystal lens panel may include a second insulating layer disposed on the first insulating layer. A plurality of second linear electrodes may be disposed on the second insulating layer. The second linear electrodes may be connected to the bus lines.

A third insulating layer may be disposed on the second insulating layer. The third insulating layer may insulate the second linear electrodes from the sealing member.

Ohmic contacts may be disposed on the third insulating layer. The ohmic contacts may be electrically connected to the common voltage line through a contact hole exposing part of the common voltage line.

The periphery of the liquid crystal lens panel may be reduced. The width of the sealing member may be increased to the width of a plurality of bus lines and the liquid crystal lens panel may be bonded.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 shows a schematic structure of a display device and a method for forming a 2D image according to an exemplary embodiment of the present invention;

FIG. 2 shows a schematic structure of a display device and a method for forming a 3D image according to an exemplary embodiment of the present invention;

FIG. 3 shows a perspective view of a liquid crystal lens panel included in a display device according to an exemplary embodiment of the present invention;

FIG. 4 shows a cross-sectional view of a liquid crystal lens panel of FIG. 3 with respect to a line IV-IV;

FIG. 5 shows a top plan view of a liquid crystal lens panel of FIG. 3 with respect to an xy plane;

FIG. 6 shows a top plan view of a liquid crystal lens panel of FIG. 3 with respect to an xy plane;

FIG. 7 shows a graph of a phase delay change following a Fresnel zone plate with a phase modulation type;

FIG. 8 shows a cross-sectional view of a part of a unit element in a liquid crystal lens panel according to an exemplary embodiment of the present invention;

FIG. 9 shows a phase delay formed depending on a position in a liquid crystal lens panel of FIG. 8;

FIG. 10 shows a top plan view of a periphery of a liquid crystal lens panel according to an exemplary embodiment of the present invention;

FIG. 11 shows a cross-sectional view of a liquid crystal lens panel with respect to a line XI-XI of FIG. 10; and

FIG. 12 shows a cross-sectional view of a liquid crystal lens panel with respect to a line XII-XII of FIG. 10.

### DETAILED DESCRIPTION

Hereinafter, exemplary embodiments of the present invention will be described more fully with reference to the accompanying drawings. The present invention may be embodied in various different forms and should not be construed as limited to the exemplary embodiments set forth herein.

Like reference numerals may refer to like elements throughout the specification and drawings.

When it is described that an element is “coupled” to another element, the element may be “directly coupled” to the other element or “electrically coupled” to the other element through a third element.

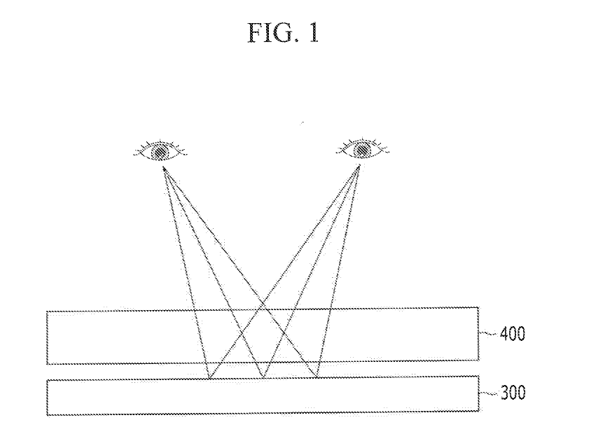

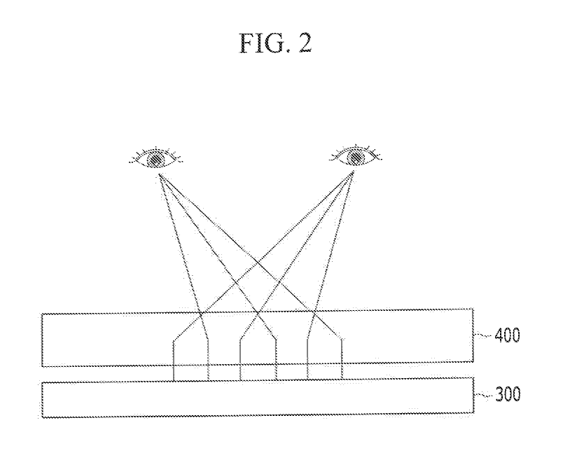

In the drawings, the thickness of layers, films, panels or regions may be exaggerated for clarity. It will be understood that when an element such as a layer, film, region, or substrate is referred to as being “on” another element, it can be directly on the other element or intervening elements may be present. FIG. 1 shows a schematic structure of a display device and a method for forming a 2D image according to an exemplary embodiment of the present invention. FIG. 2 shows a schematic structure of a display device and a method for forming a 3D image according to an exemplary embodiment of the present invention.

Referring to FIG. 1 and FIG. 2, the display device may include a display panel 300 displaying an image, and a liquid crystal lens panel 400 disposed on a surface on which the image of the display panel 300 is displayed. The display panel 300 and the liquid crystal lens panel 400 may be operable in a two-dimensional (2D) mode or a three-dimensional (3D) mode.

The display panel 300 may include various types of display panels such as a plasma display device (PDP), a liquid crystal display device, or an organic light-emitting display device. The display panel 300 may be disposed in a matrix form, and may include a plurality of pixels (PXs) that display an image. The display panel 300 may display a plane image in the 2D mode, and may alternately display images corresponding to various fields of vision such as a right eye image and a left eye image in the 3D mode in a space or time division scheme. For example, in the 3D mode, the display panel 300 may alternately display the right eye image and the left eye image for each pixel in a column.

The liquid crystal lens panel 400 may operate in the 2D mode allowing an image displayed on the display panel 300 to be displayed as a 2D image or may operate in the 3D mode allowing the image to be displayed as a 3D image. The liquid crystal lens panel 400 may allow the image displayed on the display panel 300 to be transmitted in the 20 mode without modification. The liquid crystal lens panel 400 may divide the field of vision of the image displayed on the display panel 300 in the 3D mode. For example, the liquid crystal lens panel 400 operated in the 3D mode may allow each of multiview images including a left eye image and a right eye image, which may be displayed on the display panel 300, to be displayed at the corresponding field of vision by using diffraction and refraction of light.

FIG. 1 shows the display panel 300 and the liquid crystal lens panel 400 operated in the 2D mode. In the 2D mode, the same image may reach the left eye and the right eye so that the image is displayed as the 2D image. p FIG. 2 shows the display panel 300 and the liquid crystal lens panel 400 operated in the 3D mode. The liquid crystal lens panel 400 may divide the image on the display panel 300 into the field of vision of the left eye and the field of vision of the right eye and may refract the divided images, so that the image is displayed as the 3D image.

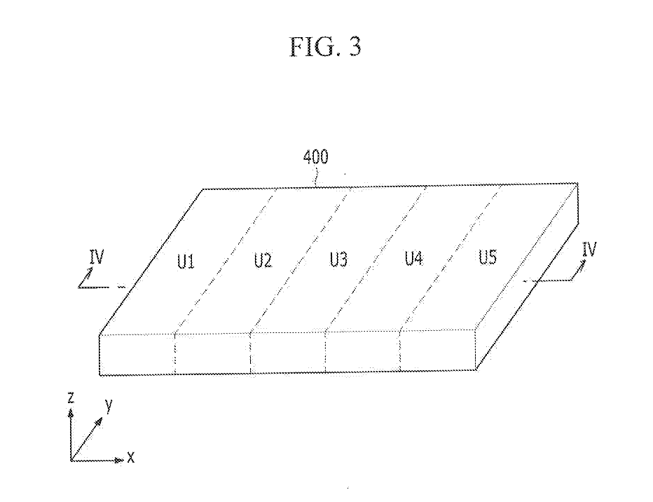

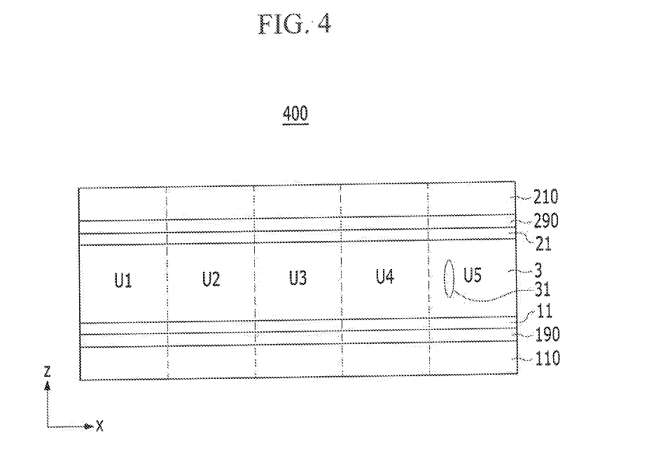

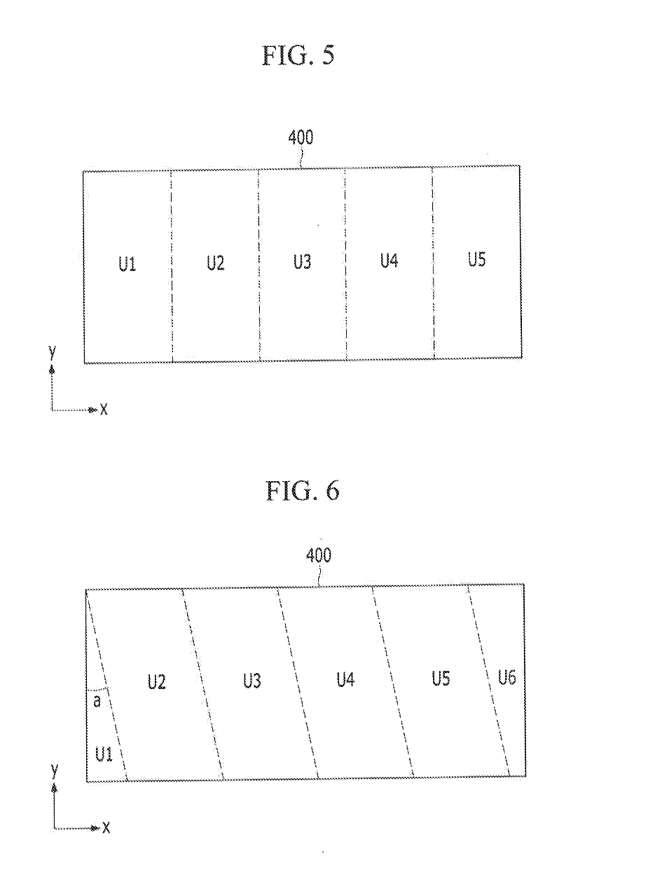

FIG. 3 shows a perspective view of a liquid crystal lens panel included in a display device according to an exemplary embodiment of the present invention. FIG. 4 shows a cross-sectional view of a liquid crystal lens panel of FIG. 3 with respect to a line IV-IV. FIG. 5 shows a top plan view of a liquid crystal lens panel of FIG. 3 with respect to an xy plane.

Referring to FIG. 3 to FIG. 5, the liquid crystal lens panel 400 may include a plurality of unit elements (U1-U5) sequentially disposed in an x-axis direction. A single unit element may cover N viewpoints (e.g., N may be a natural number) of the display panel 300. A single viewpoint may correspond to a single pixel. For example, one unit element may cover nine viewpoints. One unit element may function as a single lens.

The liquid crystal lens panel 400 may include an insulating material such as glass or plastic, and may include a first substrate 110 and a second substrate 210 facing the first substrate, and a liquid crystal layer 3 disposed between the two substrates 110 and 210.

A first electrode layer 190 and a first alignment layer 11 may be sequentially disposed on the first substrate 110. A second electrode layer 290 and a second alignment layer 21 may be sequentially disposed on the second substrate 210. The first electrode layer 190 and the second electrode layer 290 may each include a transparent conductive material such as indium tin oxide (ITO) or indium zinc oxide (IZO). The first electrode layer 190 may be patterned with a plurality of linear electrodes. The second electrode layer 290 may be a single plate-shape electrode without an additional pattern.

In FIG. 5, boundaries between the unit elements U1 to U5 of the liquid crystal lens panel 400 may be parallel with the y-axis; however, exemplary embodiments of the present invention are not limited thereto or thereby.

FIG. 6 shows a top plan view of a liquid crystal lens panel of FIG. 3 with respect to an xy plane.

Referring to FIG. 6, a liquid crystal lens panel 400 may include a plurality of unit elements U1 to U6, and boundaries between the unit elements U1 to U6 may be inclined with an angle a with respect to the y-axis. For example, the angle a may be between 10 degrees and 30 degrees.

Hereinafter, the boundaries between the unit elements U1 to U6 of the liquid crystal lens panel 400 may be inclined by the angle a with respect to the y-axis.

Referring to FIG. 4, the first electrode layer 190 and the second electrode layer 290 may generate an electric field in the liquid crystal layer 3 according to an applied voltage and may control alignment of liquid crystal molecules 31 of the liquid crystal layer 3. The alignment layers 11 and 21 may determine initial alignment of the liquid crystal molecules 31 of the liquid crystal layer 3. The liquid crystal layer 3 may be aligned according to various modes such as a horizontal alignment mode, a vertical alignment mode, a twisted nematic (TN) mode, and the like.

The liquid crystal lens panel 400 may operate in the 2D mode or the 3D mode according to a voltage applied to the first electrode layer 190 and the second electrode layer 290. When no voltage is applied to the first electrode layer 190 and the second electrode layer 290, the liquid crystal lens panel 400 may operate in the 2D mode. When a voltage is applied to the first electrode layer 190 and the second electrode layer 290, the liquid crystal lens panel 400 may operate in the 3D mode. The initial alignment of the liquid crystal molecules 31 may be controlled.

When the liquid crystal lens panel 400 operates in the 3D mode, each of the unit elements U1 to U6 of the liquid crystal lens panel 400 may function as a single lens. The initial alignment of the liquid crystal molecules 31 may be set for each of the unit elements U1 to U6 to function as a single lens.

Hereinafter, the liquid crystal lens panel 400 operating in the 3D mode will be described in more detail.

The plurality of unit elements U1 to U6 included in the liquid crystal lens panel 400 operating in the 3D mode may be disposed with a repeating pattern along a direction of a side of the liquid crystal lens panel 400. Locations of the unit elements U1 to U6 may be fixed or changed in the liquid crystal lens panel 400 at different time points.

A unit element may be a Fresnel zone plate. The Fresnel zone plate may be a lens that uses diffraction of light rather than refraction of light. The Fresnel zone plate may include a plurality of concentric circles which may be radially arranged like a Fresnel zone, and may have a distance that is narrowed toward an outer side from a center thereof.

FIG. 7 shows a graph of a phase delay change following a Fresnel zone plate with a phase modulation type. Each zone of the Fresnel zone plate may be a region to which a repeated waveform belongs.

Referring to FIG. 7, the phase delay in each zone outside of a center may be changed by an increasing number of steps. For example, in the zone at the center, the phase delay may be changed in two steps, and in the zones except for the center, the phase delay may be changed in four steps. However, exemplary embodiments of the present invention are not limited thereto or thereby.

As shown in FIG. 7, the Fresnel zone plate in which the phase delay is changed step-by-step in each zone may be a multi-level phase modulation zone plate. The liquid crystal lens panel 400 may refract light and light may be collected at a focus position through refraction and destructive as well as constructive interference of light passing through each zone. A phase delay distribution may be formed according to the Fresnel zone plate for each of the unit elements U1 to U6 of the liquid crystal lens 400 panel and a lens effect may be generated.

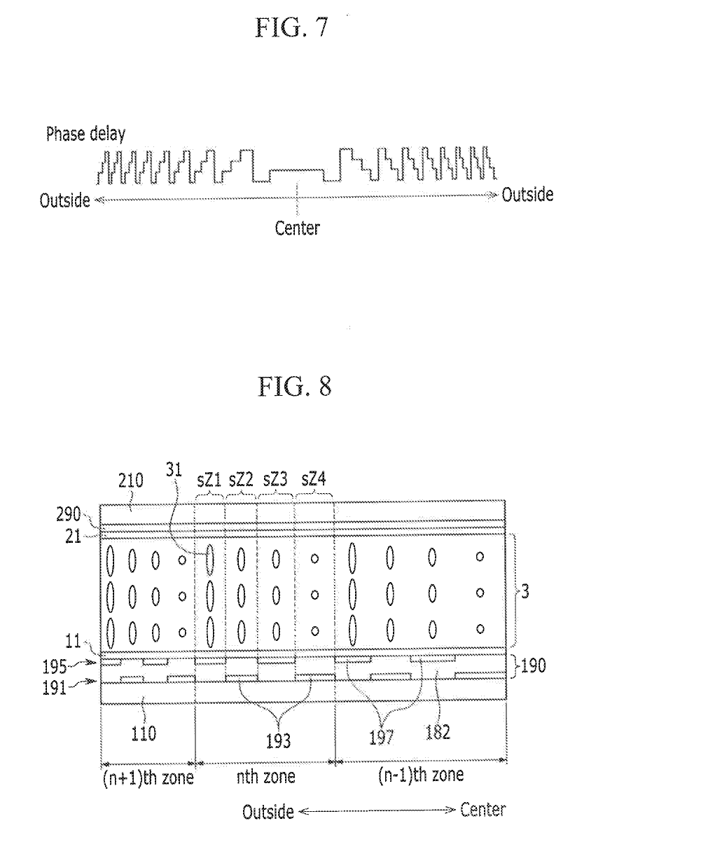

FIG. 8 shows a cross-sectional view of a part of a unit element in a liquid crystal lens panel according to an exemplary embodiment of the present invention. Reference numerals not described below may be substantially the same or similar to the corresponding reference numerals described with reference to FIG. 4 and duplicate description thereof may be omitted. Referring to FIG. 8, the liquid crystal lens panel 400 may include a first substrate 110 and a second substrate 210 facing each other, and a liquid crystal layer 3 disposed between the first and second substrates 110 and 210. A first electrode layer 190 and an alignment layer 11 may be sequentially disposed on the first substrate 110, and a second electrode layer 290 and an alignment layer 21 may be sequentially disposed on the second substrate 210.

The first electrode layer 190 may include a first linear electrode array 191 including a plurality of first linear electrodes 193, a second insulating layer 182 disposed on the first linear electrode array 191, and a second linear electrode array 195 formed on the second insulating layer 182 and including a plurality of second linear electrodes 197. A first insulating layer (not shown) may be disposed between the first substrate 110 and the first linear electrode array 191. A third insulating layer (not shown) may be disposed between the second linear electrode array 195 and the first alignment layer 11.

The first linear electrodes 193 and the second linear electrodes 197 may alternately overlap each other with reference to a horizontal direction, or might not overlap each other. In FIG. 8, edges of the first electrodes 193 and the second electrodes 197 which may be adjacent to each other might not overlap each other, but a part of the edges may slightly overlap each other.

A horizontal width of the first linear electrodes 193 and the second linear electrodes 197, a distance between the first linear electrodes 193, and a distance between the second linear electrodes 197 may gradually decrease toward an outer side from the center of the unit element, and may gradually decrease toward the outer side from the center in each zone. Two first linear electrodes 193 and two second linear electrodes 197 may be disposed in each zone of the unit element, such as an (n−1)-th zone, an n-th zone, and an (n+1)-th zone, and a region where the first and second linear electrodes 193 and 197 are disposed in each zone may form a sub-zone, such as sub-zones sZ1, sZ2, sZ3, or sZ4. For example, in the nth zone, the sub-zones from the outer side to the center may be sub-zones sZ1, sZ2, sZ3, and sZ4 in sequence. As illustrated in FIG. 8, each zone may include four sub-zones sZ1 sZ2, sZ3, and sZ4, but the number of sub-zones is not limited thereto. The horizontal widths of the first linear electrodes 193 and the second linear electrodes 197 included in each zone may be uniform, and the number of the first and second linear electrodes 193 and 197 included in each zone may be decreased toward the outer side.

In the zones, the horizontal widths of the first linear electrodes 193 and the second linear electrodes 197 may be larger than or equal to a cell gap of the liquid crystal layer 3.

The second insulating layer 182 may include an inorganic insulator or an organic insulator, and may electrically insulate between the first linear electrode array 191 and the second linear electrode array 195.

The second electrode layer 290 may be disposed on the entire surface of the second substrate 210, and may receive a predetermined voltage such as a common voltage. The second electrode layer 290 may be a common electrode. The second electrode layer 290 may include a transparent conductive material such as ITO, IZO, and the like.

The first alignment layer 11 and the second alignment layer 21 may be rubbed in a longitudinal direction (e.g., a direction vertical with respect to a surface of the drawing) which is perpendicular to a lateral direction of the first linear electrodes 193 and the second linear electrodes 197, or may be disposed in a direction forming a predetermined angle with respect to the longitudinal direction. The rubbing directions of the first alignment layer 11 on the first substrate 110 and the second alignment layer 21 on the second substrate 210 may be opposite to each other.

The liquid crystal molecules 31 of the liquid crystal layer 3 may be initially aligned in a direction which is horizontal with respect to the surfaces of the first and second substrates 110 and 210, but the alignment mode of the liquid crystal layer 3 is not limited thereto and the alignment mode of the liquid crystal layer 3 may be the vertical alignment mode and the like.

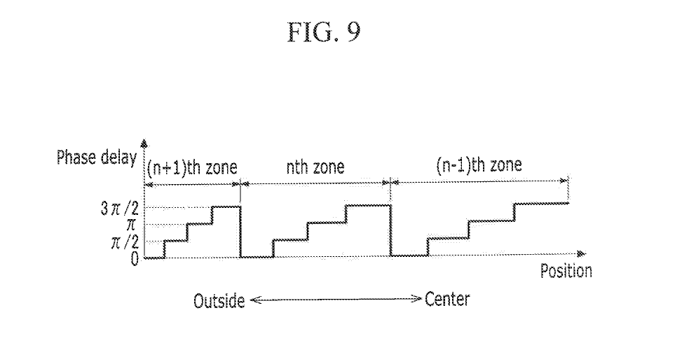

FIG. 9 shows a phase delay formed depending on a position in a liquid crystal lens panel of FIG. 8. The liquid crystal lens panel may include a phase modulation Fresnel zone plate for each unit element.

Referring to FIG. 9, each phase delay of the (n−1)-th zone, the n-th zone, and the (n+1)-th zone of the unit element may be changed through four steps. A phase delay in each of the plurality of zones may be increased step-by-step from the outer side to the center. Each corresponding sub-zone in the plurality of zones may cause the same phase delay. A slope of the phase delay for the position in the zone boundary may be substantially vertical.

The phase delay according to a location of the liquid crystal lens panel 400 can be controlled by a driving voltage applied to the first electrode layer 190 of the liquid crystal lens panel 400. The polarity of the driving voltage applied to the first electrode layer 190 may be periodically inverted and deterioration of the liquid crystal lens panel 400 may be reduced.

The liquid crystal lens panel 400 may include a periphery that corresponds to a non-display area of the display panel 300. A plurality of bus lines (not shown) applying a driving voltage to the first electrode layer 190 may be disposed on the periphery of the liquid crystal lens panel 400. A sealing member (not shown) sealing the liquid crystal layer 3 may be disposed between the first substrate 110 and the second substrate 210 and may be disposed on the periphery of the liquid crystal lens panel 400. The periphery may be minimized when the bus lines and the sealing member occupy a relatively large portion of the periphery of the liquid crystal lens panel 400.

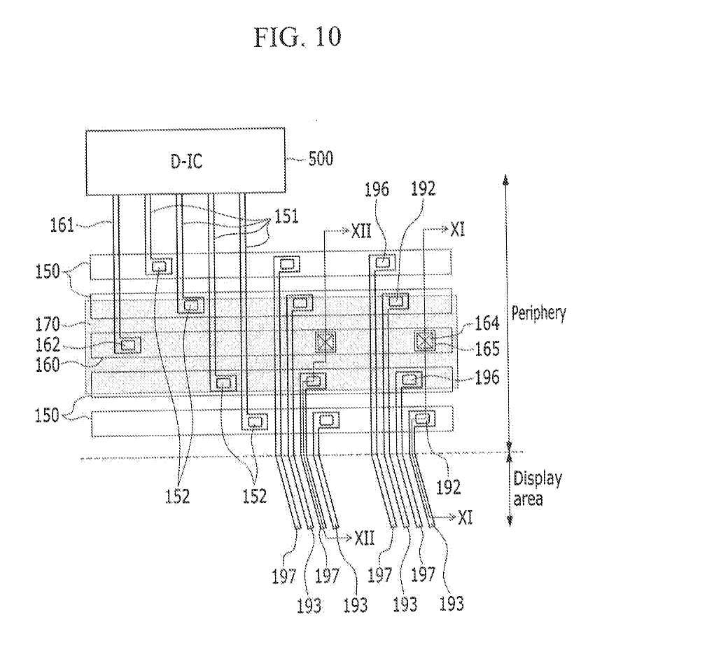

The periphery of the liquid crystal lens panel 400 will now be described in more detail with reference to FIG. 10 to FIG. 12.

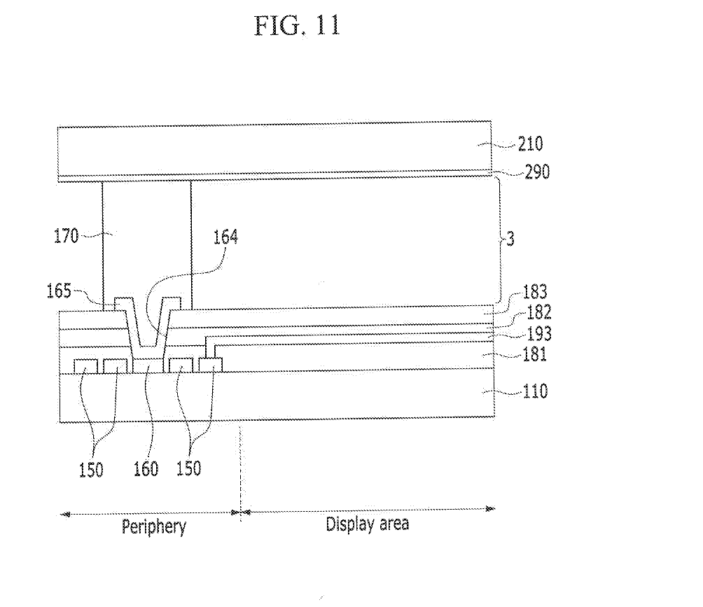

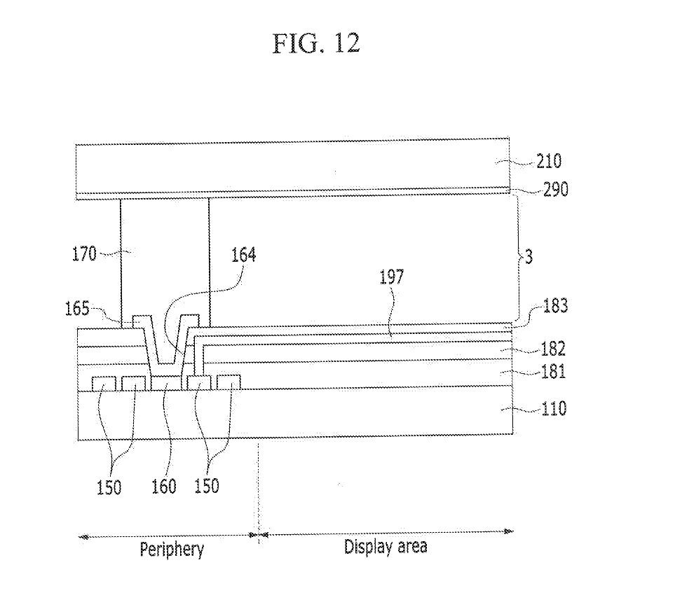

FIG. 10 shows a top plan view of a periphery of a liquid crystal lens panel according to an exemplary embodiment of the present invention. FIG. 11 shows a cross-sectional view of a liquid crystal lens panel with respect to a line XI-XI of FIG. 10. FIG. 12 shows a cross-sectional view of a liquid crystal lens panel with respect to a line XII-XII of FIG. 10.

Referring to FIG. 10 to FIG. 12, the liquid crystal lens panel 400 may include a display area and the periphery disposed outside the display area. The display area of the liquid crystal lens panel 400 may correspond to the display area of the display panel 300, and the plurality of first linear electrodes 193 and the plurality of second linear electrodes 197 may be disposed in the display area of the liquid crystal lens panel 400. The periphery of the liquid crystal lens panel 400 may correspond to the non-display area of the display panel 300, and a plurality of bus lines 150 and a common voltage line 160 may be disposed in the periphery of the liquid crystal lens panel 400.

The liquid crystal lens panel 400 may include the plurality of bus lines 150 and the common voltage line 160 disposed on the periphery. The bus lines 150 and the common voltage line 160 may be disposed on the first substrate 110. The bus lines 150 and the common voltage line 160 may be disposed on the same layer on the first substrate 110. The bus lines 150 and the common voltage line 160 may extend along an edge of the liquid crystal lens panel 400 (e.g., the periphery) and may surround the display area on the first substrate 110. The bus lines 150 and the common voltage line 160 may include a metal material having relatively high electrical conductivity, such as silver (Ag), gold (Au), platinum (Pt), copper (Cu), molybdenum (Mo), or aluminum (Al).

The bus lines 150 may be disposed along the edge of the liquid crystal lens panel 400, and the common voltage line 160 may be disposed in parallel with the bus lines 150. For example, the common voltage line 160 may be disposed between the bus lines 150, and may be disposed in a center portion between the bus lines 150. For example, as shown in FIG. 10, the common voltage line 160 may be disposed between two bus lines 150 disposed on a first side of the common voltage line 160 and another two bus lines 150 disposed on a second side of the common voltage line 160.

The liquid crystal lens panel 400 may include a driving IC 500 applying a driving voltage to the plurality of bus lines 150 and a common voltage to the common voltage line 160, a plurality of first driving lines 151 connecting the driving IC 500 and the plurality of bus lines 150, and a second driving line 161 connecting the driving IC 500 and the common voltage line 160.

A first insulating layer 181 may be disposed on the first substrate 110 on which the bus lines 150 and the common voltage line 160 may be disposed. The plurality of first driving lines 151 and the second driving line 161 may be disposed on the first insulating layer 181. A plurality of first contact holes 152 exposing a part of the bus lines 150 and a second contact hole 162 exposing a part of the common voltage line 160 may be formed on the first insulating layer 181. The first driving lines 151 may be connected to the bus lines 150 through the first contact holes 152. The second driving line 161 may be connected to the common voltage line 160 through the second contact hole 162.

The driving IC 500 may apply the common voltage to the common voltage line 160 through the second driving line 161, and an additional power supply (not shown) such as a DC-DC converter may apply the common voltage to the common voltage line 160.

The plurality of first linear electrodes 193 may be disposed on the first insulating layer 181. A plurality of third contact holes 192 exposing part of the bus lines 150 may be disposed on the first insulating layer 181. The first linear electrodes 193 may be connected to the bus lines 150 through the third contact holes 192.

The first insulating layer 181 may insulate the first driving lines 151 from the bus lines 150 and one of the first driving lines 151 may be connected to one of the bus lines 150. The first insulating layer 181 may insulate the second driving line 161 from the bus lines 150 and the second driving line 161 may be connected to the common voltage line 160. The first insulating layer 181 may insulate the first linear electrodes 193 and the bus lines 150 from each other and one of the first linear electrodes 193 may be connected to one of the bus lines 150.

The second insulating layer 182 may be disposed on the first insulating layer 181 on which the first driving line 151, the second driving line 161, and the first linear electrodes 193 may be disposed. The plurality of second linear electrodes 197 may be disposed on the second insulating layer 182. A plurality of fourth contact holes 196 exposing part of the bus lines 150 may be disposed on the first insulating layer 181 and the second insulating layer 182. The second linear electrode 197 may be connected to the bus line 150 through the fourth contact hole 196.

The second insulating layer 182 may separate the first linear electrode 193 and the second linear electrode 197, which may be disposed on different layers.

A third insulating layer 183 may be disposed on the second insulating layer 182 on which the second linear electrodes 197 may be disposed. A plurality of fifth contact holes 164 exposing part of the common voltage line 160 may be disposed on the first insulating layer 181, the second insulating layer 182, and the third insulating layer 183. The fifth contact holes 164 may be disposed on the common voltage line 160 and may be disposed at regular intervals along the common voltage line 160. A plurality of ohmic contacts 165 may be disposed on the third insulating layer 183. The ohmic contacts 165 may be electrically connected to the common voltage line 160 through the fifth contact hole 164. The ohmic contacts 165 may include a metal material such as silver (Ag), gold (Au), platinum (Pt), copper (Cu), molybdenum (Mo), or aluminum (Al).

A sealing member 170 may be disposed on the ohmic contacts 165. The sealing member 170 may be disposed on the common voltage line 160. The sealing member 170 may be disposed along the common voltage line 160 and may seal the liquid crystal layer 3. The sealing member 170 may be disposed along the periphery and may bond the first substrate 110 and the second substrate 210.

The sealing member 170 may include a conductive member and may be electrically conductive. An upper part of the sealing member 170 may be in contact with the second electrode layer 290, which may be disposed on the second substrate 210. The common voltage line 160 may be electrically connected to the second electrode layer 290 through the sealing member 170. The conductive member may be a ball including metal with relatively high electrical conductivity. The conductive member may be disposed on the sealing member 170 and the sealing member 170 may be electrically conductive.

The third insulating layer 183 may insulate the sealing member 170, which may be electrically conductive, from the second linear electrodes 197 disposed on the second insulating layer 182.

When the sealing member 170 is disposed outside the bus lines 150, a region of the sealing member 170 that is substantially equal to a width (e.g., about 0.8 mm to about 1.5 mm) of the sealing member 170 may be disposed on the outside of the bus lines 150.

When disposing the common voltage line 160 together with the bus lines 150 and disposing the sealing member 170 electrically connecting the common voltage line 160 to the second electrode layer 290 on the bus lines 150 and the common voltage line 160, no additional region of the sealing member 170 need be disposed on the periphery of the liquid crystal lens panel 400 and a size of the periphery may be reduced. The width of the bus lines 150 may be about 3 mm and the width of the sealing member 170 may be about 3 mm such that the first substrate 110 may be bonded more firmly to the second substrate 210.

While the present invention has been shown and described with reference to the exemplary embodiments thereof, it will be apparent to those of ordinary skill in the art that various changes in form and detail may be made thereto without departing from the spirit and scope of the present invention.

What is claimed is:

1. A liquid crystal lens panel, comprising:
a display area;
a periphery area disposed outside of the display area;
a first substrate including a plurality of linear electrodes disposed on the display area;
a plurality of bus lines disposed on the periphery area;
a common voltage line disposed parallel to the plurality of bus lines;
a second substrate including a common electrode, the second substrate facing the first substrate; and
a sealing member disposed along the periphery area and bonding the first substrate and the second substrate to each other, wherein
the common voltage line is disposed between each of the plurality of bus lines and the sealing member is disposed on the common voltage line, and wherein the sealing member electrically connects the common voltage line and the common electrode.

2. The liquid crystal lens panel of claim 1, further including
a first insulating layer disposed on the first substrate.

3. The liquid crystal lens panel of claim 2, wherein
the plurality of linear electrodes include a plurality of first linear electrodes and a plurality of second linear electrodes connected to the plurality of bus lines, and wherein the plurality of first linear electrodes are disposed on the first insulating layer.

4. The liquid crystal lens panel of claim 3, further comprising a driving IC configured to apply a driving voltage to the plurality of bus lines, and a plurality of first driving lines connecting the driving IC and the plurality of bus lines.

5. The liquid crystal lens panel of claim 4, wherein the first driving lines are disposed on the first insulating layer.

6. The liquid crystal lens panel of claim 4, further comprising a second driving line connecting the driving IC and the common voltage line, wherein the driving IC is configured to apply a common voltage to the common voltage line.

7. The liquid crystal lens panel of claim 6, wherein the second driving line is disposed on the first insulating layer.

8. The liquid crystal lens panel of claim 3, further comprising a second insulating layer disposed on the first insulating layer, wherein the second linear electrodes are disposed on the second insulating layer.

9. The liquid crystal lens panel of claim 8, further comprising a third insulating layer disposed on the second insulating layer and insulating the second linear electrodes from the sealing member.

10. The liquid crystal lens panel of claim 9, further comprising ohmic contacts disposed on the third insulating layer, wherein the ohmic contacts are electrically connected to the common voltage line through a contact hole exposing at least part of the common voltage line.

11. The liquid crystal lens panel of claim 10, wherein a plurality of contact holes are disposed at regular intervals on the common voltage line.

12. The liquid crystal lens panel of claim 10, wherein the sealing member is disposed on the ohmic contacts, and an upper portion of the sealing member is in contact with the common electrode.

13. The liquid crystal lens panel of claim 1, further comprising a liquid crystal layer disposed between the first substrate and the second substrate, wherein the sealing member seals the liquid crystal layer.

14. A display device, comprising:
a display panel configured to display an image; and
a liquid crystal lens panel configured to operate in a two-dimensional (2D) mode displaying a 2D image and a three-dimensional (3D) mode displaying a 3D image, wherein
the liquid crystal lens panel comprises:
a first substrate including a plurality of bus lines disposed on a periphery of the liquid crystal lens panel, wherein the periphery is disposed outside a display area, and a common voltage line disposed between each of the plurality of bus lines,
a second substrate including a common electrode, the second substrate facing the first substrate, and
a sealing member disposed on the common voltage line, wherein the sealing member bonds the first substrate and the second substrate to each other, and wherein the sealing member electrically connects the common voltage line and the common electrode.

15. The display device of claim 14, wherein the liquid crystal lens panel further comprises a first insulating layer disposed on the first substrate.

16. The display device of claim 15, wherein the liquid crystal lens panel further comprises:
a plurality of first linear electrodes disposed on the first insulating layer, wherein the first linear electrodes are connected to the bus lines;
a driving IC configured to apply a driving voltage to the bus lines; and
a plurality of first driving lines disposed on the first insulating layer and connecting the driving IC to the bus lines.

17. The display device of claim 16, wherein the liquid crystal lens panel further comprises a second driving line disposed on the first insulating layer and connecting the driving IC and the common voltage line.

18. The display device of claim 17, wherein
the liquid crystal lens panel further comprises:
a second insulating layer disposed on the first insulating layer; and
a plurality of second linear electrodes disposed on the second insulating layer, wherein the second linear electrodes are connected to the bus lines.

19. The display device of claim 18, further comprising a third insulating layer disposed on the second insulating layer, wherein the third insulating layer insulates the second linear electrodes from the sealing member.

20. The display device of claim 19, further comprising ohmic contacts disposed on the third insulating layer, wherein the ohmic contacts are electrically connected to the common voltage line through a contact hole exposing part of the common voltage line.
